(19) United States
(12) Patent Application Publication
(10) Pub. No.: US 2014/0177739 A1
(43) Pub. Date: Jun. 26, 2014

(54) TRANSMISSION DEVICE AND NODE FOR THE SAME

(71) Applicant: Denso Corporation, Kariya-city (JP)

(72) Inventors: Nobuaki Matsudaira, Chiryu-city (JP); Shigeki Ohtsuka, Kariya-city (JP); Hironobu Akita, Okazaki-city (JP); Hirofumi Yamamoto, Obu-city (JP)

(21) Appl. No.: 14/032,224

(22) Filed: Sep. 20, 2013

(30) Foreign Application Priority Data
Dec. 26, 2012 (JP) 2012-282516

(51) Int. Cl. H04B 3/30

(52) U.S. Cl. CPC H04B 3/30
USPC 375/257

(57) ABSTRACT

Nodes are connected in parallel between two transmission lines and configured to utilize a telecommunications standard of a differential transmission. At least one of the nodes includes two input/output terminals, a driver, a receiver, a resistor, and a comparator. The two input/output terminals are connected to the two transmission lines. The driver includes two output terminals connected to the two input/output terminals. The receiver includes two input terminals connected to the two input/output terminals. The resistor is connected between each of the two input/output terminals and one of a grand and a power supply voltage. The comparator compares a voltage between the transmission lines with a reference voltage to determine whether the transmission lines are in an idle state or in a communication state.

### CROSS REFERENCE TO RELATED APPLICATION

This application is based on reference Japanese Patent Application No. 2012-282516 filed on Dec. 26, 2012, the disclosure of which is incorporated herein by reference.

### TECHNICAL FIELD

The present disclosure relates to a transmission device having a communications configuration in which multiple nodes are connected to a transmission line to use a telecommunications standard of a differential transmission. The present disclosure further relates to the node for the transmission device.

### BACKGROUND

Telecommunications Industry Association (TAI) of the United States proposes a multipoint-low voltage differential signaling (MLVDS) enabling a configuration of a multipoint connection. For example, a Non-patent Document 1 describes the communications standard of MLVDS. The present communications standard permits connection of 32 nodes and operation of the nodes at 250 Mbps at maximum. It is noted that, in the present communications standard, it is difficult to detect an idle section in which data does not exist in a transmission line. As follows, this issue will be described in detail.

In a multipoint connection configuration, multiple nodes are connected to a transmission line. In such a multipoint connection configuration, an idle section, where none of the nodes sends data, exists. In this idle section, a differential amplitude is substantially 0V, and therefore, a common electric potential becomes unstable. Thus, an output of a receiver of the node becomes unstable and may be erroneously recognized as data. In order to avoid such an erroneous recognition, each of the nodes needs to determine whether the present state is in the idle section according to the bus potential and to mask received data in the idle section.

(Non-patent Document 1) TINEIA-899

(Non-patent Document 2) Copy of website of CXB1463R-W/1464R-W

The configuration of the Non-patent Document 1 employs a Type-1 receiver and a Type-2 receiver respectively having input threshold values, which are different from each other. The Type-2 receiver has an input threshold value having an offset of +100 mV. Therefore, the Type-2 receiver sends a low-level signal in the idle section and enables to avoid a malfunction. Nevertheless, due to the offset of the input threshold value, duty value of the data is modulated to result in increase in a duty cycle distortion (DCD) jitter. Consequently, it is concerned to cause an error in usual communications.

Herein, a squelch circuit is known as a typical circuit configured to detect the idle section. For example, USB 2.0 employs a squelch circuit. The squelch circuit of USB 2.0 includes a receiver configured to receive a differential amplitude of 150 mV at minimum. The squelch circuit is configured to send a low-level signal, when detecting a differential amplitude greater than or equal to 150 mV, and to recognize reception of a signal. Alternatively, the squelch circuit determines, when detecting a differential amplitude of 100 mV or less, to receive a noise and sends a high-level signal. In this case, the squelch circuit masks the received data during detecting the differential amplitude of 100 mV or less. The present configuration allows variation in the threshold values of the differential amplitude in a rage between 100 mV and 150 mV due to certain factors, such as temperature, voltage, and variation in a process.

In a multipoint connection configuration employing such a squelch circuit, the maximum threshold value of the differential amplitude needs to be set to a small value such as 50 mV, since influence of reflection and noise is large in communications in a multipoint connection configuration, dissimilarly to the USB-2.0 configuration employing a point-to-point connection configuration. Thus, the threshold value of the input signal of the receiver needs to be set to such a small value about 50 mV. In actual circuit design, it is necessary to permit a variation similar to a variation in a USB-2.0 configuration. Therefore, in a case where a variation range is set to 50 mV, the variation range of the threshold value becomes 0 mV to 50 mV. In such a case, a noise level cannot be specified. Thus, it is difficult to employ a squelch circuit in a multipoint connection configuration.

Herein, for example, a gigabit video interface (GVIF) is generally known as a communication technology (see Non-patent Document 2). Nevertheless, it is noted that, the GVIF is employed in a point-to-point (single-node to single-node) connection configuration and is different from the multipoint connection configuration, which is herein discussed.

### SUMMARY

It is an object of the present disclosure to produce a transmission device configured to detect an idle section appropriately by utilizing MLVDS telecommunications standard. It is an object of the present disclosure to produce a node for the transmission device.

According to an aspect of the present disclosure, a transmission device comprises two transmission lines. The transmission device further comprises a plurality of nodes connected in parallel between the two transmission lines and configured to utilize a telecommunications standard of a differential transmission. At least one of the nodes includes two input/output terminals connected to the two transmission lines. The at least one of the nodes further includes a driver including two output terminals connected to the two input/output terminals. The at least one of the nodes further includes a receiver including two input terminals connected to the two input/output terminals. The at least one of the nodes further includes a resistor connected between each of the two input/output terminals and one of the grand and the power supply voltage. The at least one of the nodes further includes a comparator configured to compare a voltage between the two transmission lines with a reference voltage to determine whether the two transmission lines are in an idle state or in a communication state.

According to another aspect of the present disclosure, a node for a transmission device including two transmission lines, the node connected in parallel between the two transmission lines and configured to utilize a telecommunications standard of a differential transmission, the node comprises two input/output terminals connected to the two transmission lines. The node further comprises a driver including two output terminals connected to the two input/output terminals. The node further comprises a receiver including two input terminals connected to the two input/output terminals. The node further comprises a resistor connected between each of the two input/output terminals and one of the grand and the power supply voltage. The node further comprises a comparator configured to compare a voltage between the two transmission lines with a reference voltage to determine whether the two transmission lines are in an idle state or in a communication state.

### BRIEF DESCRIPTION OF THE DRAWINGS

The above and other objects, features and advantages of the present invention will become more apparent from the following detailed description made with reference to the accompanying drawings. In the drawings:

FIG. 1 is an electric circuit diagram showing a node according to a first embodiment of the present disclosure;

FIG. 2 is an electric schematic showing an outline of a transmission device including the nodes;

FIG. 3 is a time chart showing an operation of the transmission device according to the first embodiment;

FIG. 4 is an electric circuit diagram showing a node according to a second embodiment of the present disclosure;

FIGS. 5A is a time chart showing an operation of a transmission device according to a comparative embodiment, and FIG. 5B is a time chart showing an operation of a transmission device according to the second embodiment;

FIG. 6 is an electric circuit diagram showing a node according to a third embodiment of the present disclosure; and

FIG. 7 is a time chart showing an operation of a transmission device according to the third embodiment.

### DETAILED DESCRIPTION

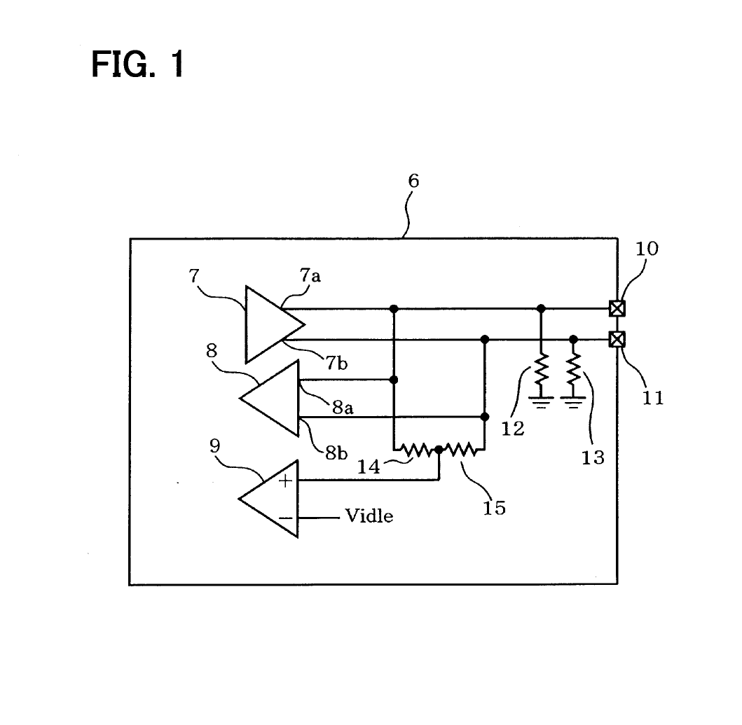

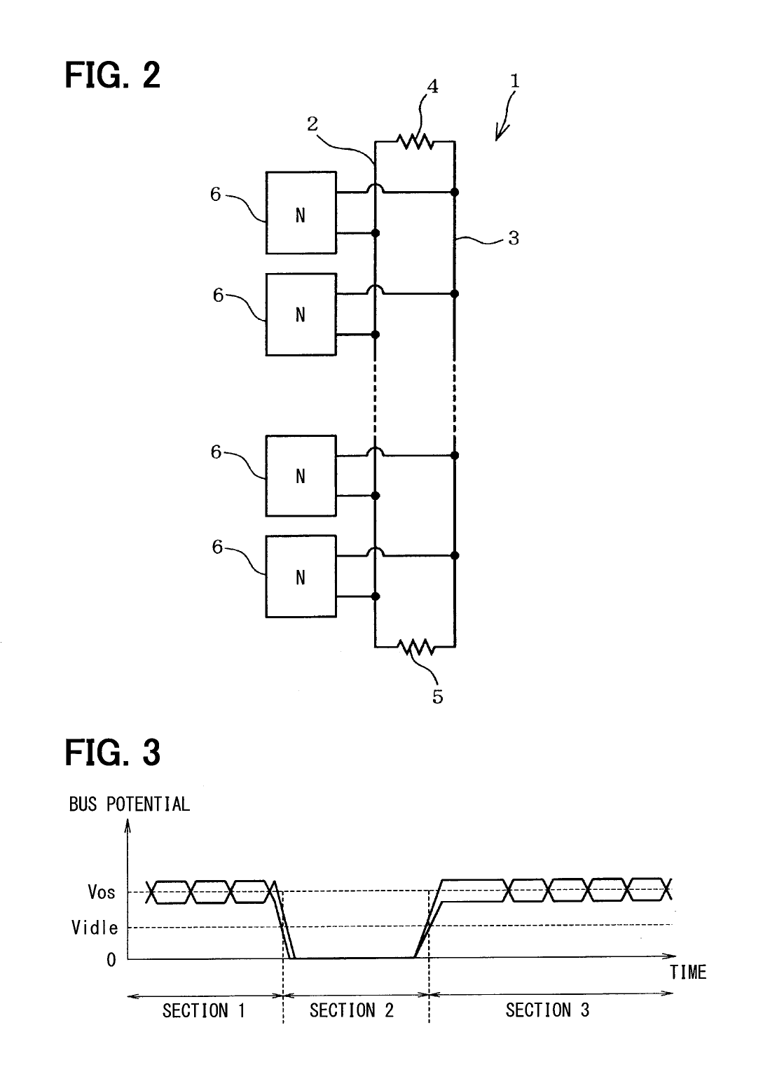

As follows, a first embodiment of the present disclosure will be described with reference to FIGS. 1 to 3. FIG. 2 is a schematic view showing an electronic configuration of a transmission device 1 according to the present embodiment. The transmission device 1 has a communicable configuration in compliance with a MLVDS telecommunications standard. As shown in FIG. 2, the transmission device 1 includes two transmission lines 2 and 3, two termination resistors 4 and 5, and multiple nodes 6. Each of the two termination resistors 4 and 5 is connected between the two transmission lines 2 and 3. The multiple nodes 6 are connected in parallel with each other between the two transmission lines 2 and 3.

As shown in FIG. 1, each of the nodes 6 includes a driver 7, a receiver 8, and a comparator 9. The driver 7 includes two output terminals 7a and 7b connected to input/output terminals 10 and 11, respectively. The input/output terminals 10 and 11 are connected to the two transmission-lines 2 and 3 (FIG. 2), respectively. The receiver 8 includes two input terminals 8a and 8b connected to the input/output terminals 10 and 11, respectively.

A pull down resistor 12 is connected between the input/output terminal 10 and the grand GND. A pull down resistor 13 is connected between the input/output terminal 11 and the grand GND. Each of the pull down resistors 12 and 13 has a resistance, which is sufficiently greater than an output impedance of the driver 7 in the node 6. In the present configuration, when the driver 7 is in operation and when the driver 7 sends data, a common mode voltage of the transmission lines 2 and 3 is an output common mode voltage Vos of the driver 7, such as 1.25V. Alternatively, when the driver 7 is in an idle section and is not in operation, the driver 7 does not send data. In this case, a bus voltage between the transmission lines 2 and 3 is a grand electric potential (0V).

A series circuit including two resistors 14 and 15 is connected between the input/output terminals 10 and 11. The two resistors 14 and 15 have an intermediate connection point therebetween, and the intermediate connection point is connected with one input terminal (+) of the comparator 9. The comparator 9 has another input terminal (−) applied with a reference voltage (first reference voltage) Vidle, such as 0.5V, generated in the node 6. In the present configuration, the comparator 9 compares the common mode voltage between the input/output terminals 10 and 11 with the reference voltage Vidle. That is, the comparator 9 compares the common mode voltage between the transmission lines 2 and 3 with the reference voltage Vidle. In this way, the comparator 9 determines whether the transmission lines 2 and 3 are in the idle state (idle section) or in a communication state. More specifically, the comparator 9 is configured to determine that the transmission lines 2 and 3 are in the idle state when the common mode voltage of the bus is lower than the reference voltage Vidle. Alternatively, the comparator 9 is configured to determine that the transmission lines 2 and 3 are in the communication state when the common mode voltage of the bus is higher than the reference voltage Vidle.

Subsequently, an operation effect of the above-described configuration will be described with reference to FIG. 3. In FIG. 3, the section 1 represents a state where, for example, the driver 7 of the node 6, which is the upper first one in FIG. 2, is in a transmission state and sends data. In FIG. 3, the section 2 represents a state where the transmission lines 2 and 3 are in an idle state (idle section). In FIG. 3, the section 3 represents a state where, for example, the driver 7 of the node 6, which is upper second one in FIG. 2, is in the transmission state and sends data.

In the section 1 shown in FIG. 3, the driver 7 of the first node 6 is in the transmission state, and the common mode voltage of the bus becomes the output common mode voltage Vos of the driver 7. Therefore, the common mode voltage of the bus becomes higher than the reference voltage Vidle. Thus, the comparator 9 determines that the transmission lines 2 and 3 are in the communication state. Subsequently, in the section 2 shown in FIG. 3, the transmission lines 2 and 3 are in the idle state, and the bus voltage becomes the grand electric potential. Therefore, the common mode voltage of the bus becomes lower than the reference voltage Vidle. Thus, the comparator 9 determines that the transmission lines 2 and 3 are in the idle state. Subsequently, in the section 3 shown in FIG. 3, the driver 7 of the second node 6 is in the transmission state, and the common mode voltage of the bus becomes the output common mode voltage Vos of the driver 7. Therefore, the common mode voltage of the bus becomes higher than the reference voltage Vidle. Thus, the comparator 9 determines that the transmission lines 2 and 3 are in the communication state. In FIG. 3, a differential amplitude of the data signal when the transmission lines 2 and 3 are in the communication state is greater than or equal to 50 mV.

In the configuration according to the present embodiment, the common mode voltage (bus voltage) of the transmission lines 2 and 3 in the idle state is set to the grand electric potential. Therefore, the present configuration enables secure and appropriate determination whether the transmission lines 2 and 3 are in the idle state or in the communication state. Thus, it is not necessary to employ a conventional configuration including a large DCD-jitter device such as a Type-2 receiver. Therefore, the present configuration enables communications with a high tolerance to noise.

As described above in the BACKGROUND, the gigabit video interface (GVIF) is employed in a point-to-point (single-node to single-node) connection configuration and is different from the configuration of the present disclosure, which employs the multipoint connection configuration. It is further noted that, the GVIF utilizes the common mode voltage for implementing frequency negotiation. To the contrary, the transmission device according to the present disclosure utilizes the common mode voltage for detection of the idle state in the multipoint connection configuration. Therefore, the configuration of the present disclosure is different from a configuration employing GVIF.

In the above-described embodiment, the bus voltage of the transmission lines 2 and 3 in the idle state is set to the grand electric potential by using the pull down resistors 12 and 13. It is noted that, the bus voltage of the transmission lines 2 and 3 in the idle state may be set to a power supply voltage VDD, such as 3.3V, by using pull up resistors, in place of the pull down resistors 12 and 13.

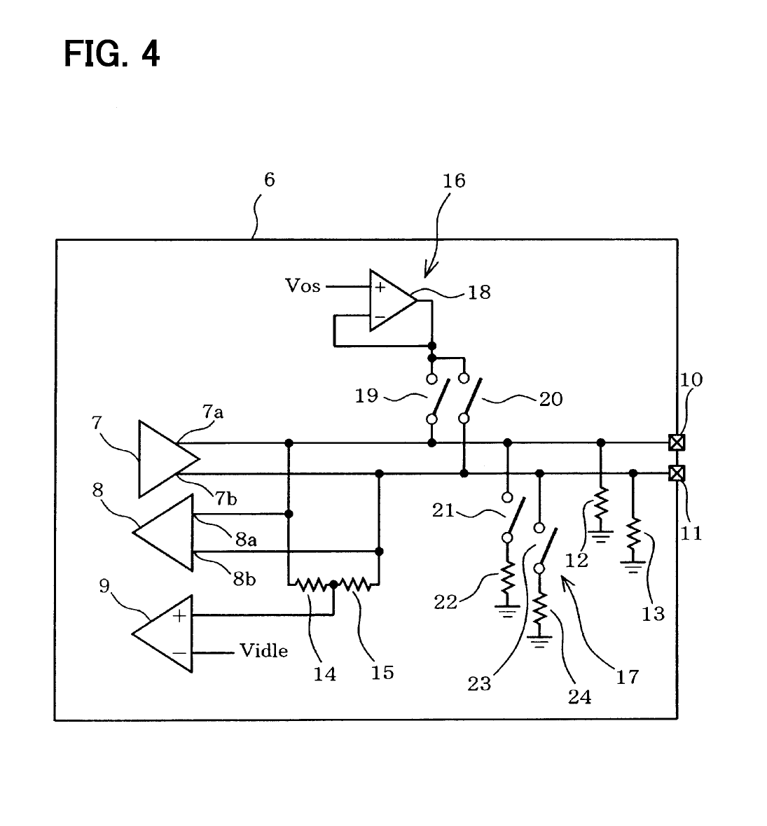

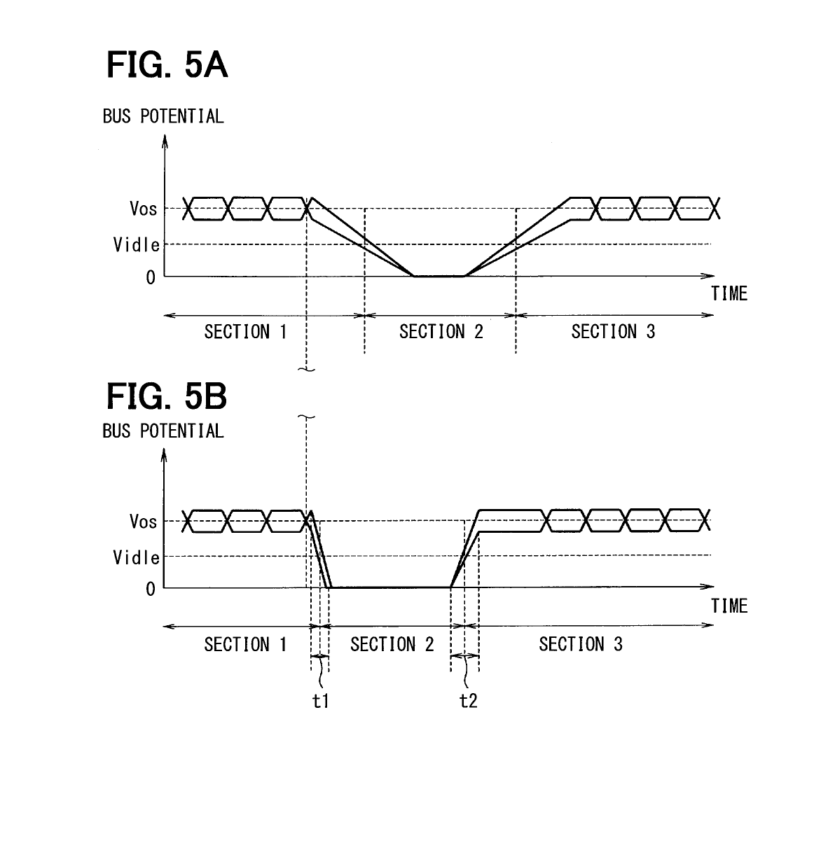

FIGS. 4 and 5 show a second embodiment of the present disclosure. The same reference numerals are noted to elements identical to those in the first embodiment. In a case where a voltage pull-in time of a driver or a pull down resistor becomes large, efficiency of the communications may be impaired. In order to address such a concern, in the second embodiment, a circuitry configuration is employed to reduce the voltage pull-in time of a driver or a pull down resistor.

Specifically, as shown in FIG. 4, each node 6 is equipped with a pre-charge circuit 16 and a pre-discharge circuit 17. The pre-charge circuit 16 employs a switched voltage-follower configuration including an operational amplifier 18 and switches 19 and 20. The switch 19 is connected between the output terminal of the operational amplifier 18 and the input/output terminal 10. The switch 20 is connected between the output terminal of the operational amplifier 18 and the input/output terminal 11. The operational amplifier 18 has one input terminal (+) applied with an output common mode voltage Vos of the driver 7. The operational amplifier 18 has another input terminal (−) connected to the output terminal of the operational amplifier 18. When the switches 19 and 20 are turned ON (activated), the pre-charge circuit 16 quickly pulls in the voltage between the input/output terminals 10 and 11, i.e., the voltage between the transmission lines 2 and 3 to the output common mode voltage Vos of the driver 7.

The pre-discharge circuit 17 is configured with switched low-value resistors. More specifically, the pre-discharge circuit 17 includes a series circuit including a switch 21 and a resistor 22, which are connected between the input/output terminal 10 and the grand GND. The pre-discharge circuit 17 further includes a series circuit including a switch 23 and a resistor 24, which are connected between the input/output terminal 11 and the grand GND. The resistors 22 and 24 have resistance values lower than the resistance values of the pull down resistors 12 and 13. When the switches 21 and 23 are turned ON (activated), the pre-discharge circuit 17 quickly pulls in the voltage between the input/output terminals 10 and 11, i.e., the voltage between the transmission lines 2 and 3 to the ground voltage of the ground GND.

Subsequently, an operation effect of the above-described configuration will be described with reference to FIGS. 5A and 5B. FIG. 5A shows an operation of a configuration, which is not equipped with both the pre-charge circuit 16 and the pre-discharge circuit 17. In the case of FIG. 5A, the voltage pull-in time of the driver 7 and the pull down resistors 12 and 13 is large, due to a large number of the nodes 6 and/or due to a large wiring capacity caused by a large wire length of the transmission lines 2 and 3.

Contrary to the configuration of FIG. 5A, FIG. 5B shows an operation state of the configuration equipped with the pre-charge circuit 16 and the pre-discharge circuit 17 according to the second embodiment. It is noted that, the number of the nodes 6 and the wire length of the transmission lines 2 and 3 are set to the same values. In FIG. 5, the section 1 represents a state where the driver 7 of the node 6, which is the upper first one in FIG. 2, is in the transmission state and sends data. In FIG. 5, the section 2 represents a state where the transmission lines 2 and 3 are in the idle state. In FIG. 5, the section 3 represents a state where the driver 7 of the node 6, which is upper second one in FIG. 2, is in the transmission state and sends data.

In FIG. 5B, in addition to the above-described operations, the switches 21 and 23 of the pre-discharge circuit 17 are turned ON (activated) in the time section t1, and the switches 19 and 20 of the pre-charge circuit 16 are turned ON (activated) in the time section t2.

The configuration of the second embodiment other than the above-described configuration is equivalent to that of the first embodiment. Therefore, in the second embodiment, an operation effect equivalent to that of the first embodiment can be produced. In particular, the configuration according to the second embodiment is equipped with the pre-charge circuit 16 and the pre-discharge circuit 17. Therefore, as shown in FIG. 5B, the voltage pull-in time of the driver or the pull down resistor can be reduced, even when the number of the nodes is large and/or even when the wire length is large to cause a large wiring capacity. Thus, efficiency of communications can be enhanced.

In the second embodiment, the bus voltage of the transmission lines 2 and 3 in the idle state is set to the grand electric potential by using the pull down resistors 12 and 13. It is noted that, the bus voltage of the transmission lines 2 and 3 in the idle state may be set to the power supply voltage VDD by using pull up resistors, in place of the pull down resistors 12 and 13. In this configuration, the pre-discharge circuit 17 may employ a configuration, such as a switched low-resistor configuration, to pull in the bus voltage to the power supply voltage VDD quickly.

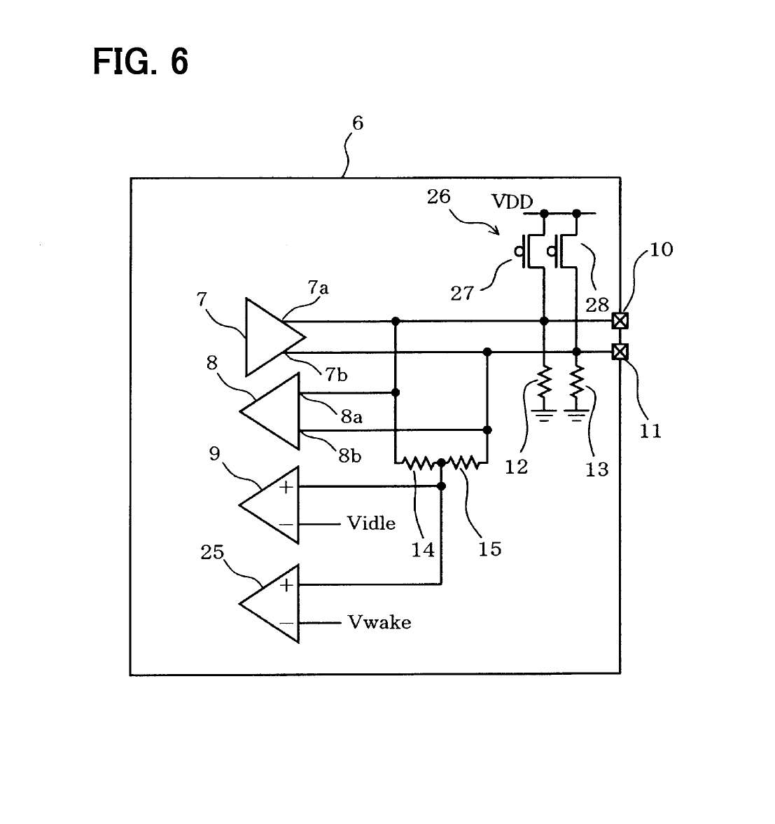

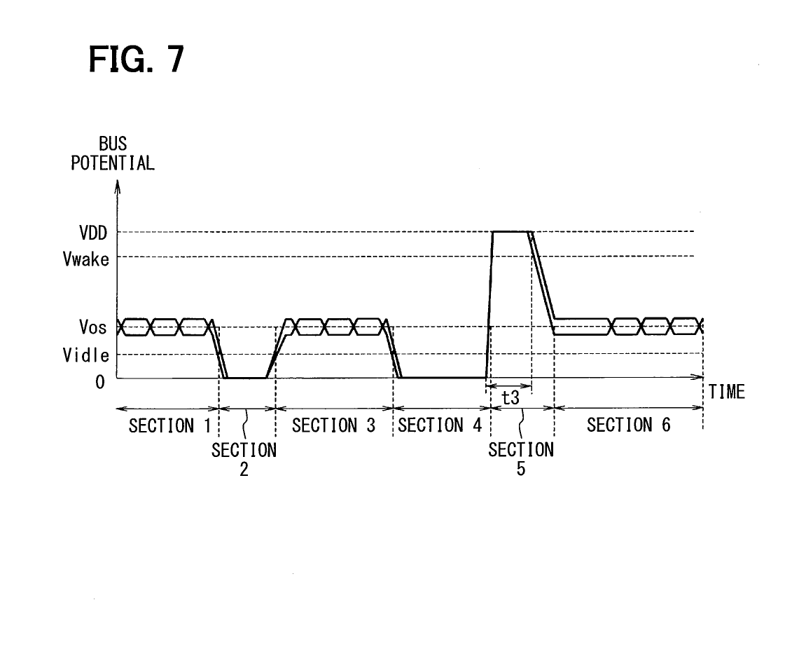

FIGS. 6 and 7 show a third embodiment of the present disclosure. The same reference numerals are noted to elements identical to those in the first embodiment. The configuration according to the third embodiment employs a partial network by utilizing a voltage level, which does not occur in a normal signal transmission state. The partial network employs a communications configuration to de-activate (power-down) a part of nodes 6 to be in a sleep state among multiple nodes 6 connected to the transmission lines 2 and 3. Thus, data exchange is implemented among remaining nodes 6.

Specifically, as shown in FIG. 6, each of the nodes 6 is equipped with a wakeup comparator 25 and a wakeup signal generator circuit 26. The comparator 25 has one input terminal (+) connected with the intermediate connection point between the two resistors 14 and 15. The comparator 25 has the other input terminal (−) applied with a second reference voltage Vwake at a voltage level, which does not occur in the normal signal transmission state, as shown in FIG. 7. The reference voltage Vwake is at a voltage generated in the node 6. The comparator 25 compares the second reference voltage Vwake with the common mode voltage (bus voltage) between the input/output terminals 10 and 11, i.e., the common mode voltage between the transmission lines 2 and 3. In this way, the comparator 25 determines whether to have received a wakeup signal at the voltage level, which does not occur in the normal signal transmission state, as shown in the section 5 in FIG. 7. The wakeup signal generator circuit 26 is configured to generate the wakeup signal. The wakeup signal generator circuit 26 includes PMOS elements 27 and 28 for wakeup signals. The PMOS element 27 is connected between the input/output terminal 10 (transmission line 2) and the power supply voltage VDD. The PMOS element 28 is connected between the input/output terminal 11 (transmission line 3) and the power supply voltage VDD.

Subsequently, an operation effect of the configuration, i.e., the partial network, will be described with reference to FIG. 7.

It is noted that, in the present embodiment, the output common mode voltage Vos of the driver 7 is set to a low voltage value, which is lower than ½ VDD, i.e., lower than the half value of VDD. In this way, the present configuration has an additional margin, such that the bus voltage does not exceed the second reference voltage Vwake in the signal transmission state. In addition, each of the PMOS elements 27 and 28 for the wakeup signal has a sufficiently large size to enable to pull in the bus voltage to the power supply voltage VDD when being activated (turned ON).

In the section 1 shown in FIG. 7, the driver 7 of the node 6, which is the upper first one in FIG. 2, is in the transmission state and sends data. In the present section 1, it is assumed that the first node 6 sends a command to de-activate the node 6, which is on the upper second one in FIG. 2, to cause the second node 6 to be in the sleep state. In this way, the second node 6 is caused to be in the sleep state in response to the sleep command. Consequently, in the section 3 shown in FIG. 7, the second node 6 is caused to be in the sleep state, and the data exchange is implemented among other nodes 6. In the present state, the second node 6 is caused to be in the sleep state, however, only the wakeup comparator 25 is activated to monitor the bus voltage.

Subsequently, in the section 5 shown in FIG. 7, one of the nodes 6, which is not in the sleep state and is activated, sends a wakeup signal. Specifically, the PMOS elements 27 and 28 of the wakeup signal generator circuit 26 are activated, thereby to set the bus voltage of the transmission lines 2 and 3 at the power supply voltage VDD. In FIG. 7, the PMOS elements 27 and 28 are activated in the time section t3. As described above, when the bus voltage increases to the power supply voltage VDD, the comparator 25 of the node 6, which is presently in the sleep state, detects that the bus voltage increases to be higher than the second reference voltage Vwake, thereby to determine to receive the wakeup signal. In this way, the node 6, which is in the sleep state, is caused to wakeup to return to its normal operation. Subsequently, in the section 6 shown in FIG. 7, all the nodes 6 are in the communication state to exchange data thereamong.

The configuration of the third embodiment other than the above-described configuration is equivalent to that of the first embodiment. Therefore, in the third embodiment, an operation effect equivalent to that of the first embodiment can be produced. In particular, the node 6 according to the third embodiment is equipped with the wakeup comparator 25 and the wakeup signal generator circuit 26. In addition, the node 6 according to the third embodiment is configured to utilize, as the wakeup signal, the voltage level, which does not occur in the normal signal transmission state. Thus, the configuration according to the third embodiment enables to produce the partial network. Thus, the partial network produced in this way enables to cause the node 6, which is irrelative to the operation, to be in the sleep state, thereby to reduce power consumption.

In the third embodiment, the bus voltage of the transmission lines 2 and 3 in the idle state is set to the grand electric potential by using the pull down resistors 12 and 13. It is noted that, the bus voltage of the transmission lines 2 and 3 in the idle state may be set to the power supply voltage VDD by using pull up resistors, in place of the pull down resistors 12 and 13. In this configuration, it may be desirable to set the electric potential of the wakeup signal to the grand electric potential or to an electric potential higher than the power supply voltage VDD.

In the third embodiment, the wakeup comparator 25 and the wakeup signal generator circuit 26 are equipped to the node 6 according to the first embodiment. The configuration of the node 6 is not limited to the above-described configuration in the third embodiment. The wakeup comparator 25 and the wakeup signal generator circuit 26 may be equipped to the node 6 according to the second embodiment.

As described above, the transmission device according to the present disclosure includes the two transmission lines 2, 3 and the multiple nodes 6. The multiple nodes 6 are connected in parallel between the two transmission lines and are configured to utilize the telecommunications standard of differential transmission. The node includes the two input/output terminals 10, 11 connected to the two transmission lines. The node further includes the driver including the two output terminals 7a, 7b connected to the two input/output terminals 10, 11. The node further includes the receiver 8 including the two input terminals 8a, 8b connected to the two input/output terminals 10, 11. The node further includes the resistor 12, 13 connected between each of the two input/output terminals 10, 11 and one of the grand GND and the power supply voltage VDD. The node further includes the comparator 9 configured to compare the voltage between the transmission lines 2, 3 with the reference voltage and to determined whether the transmission lines 2, 3 are in the idle state or in the communication state.

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A transmission device comprising:
two transmission lines; and
a plurality of nodes connected in parallel between the two transmission lines and configured to utilize a telecommunications standard of a differential transmission, wherein
at least one of the nodes includes:
two input/output terminals connected to the two transmission lines;
a driver including two output terminals connected to the two input/output terminals;
a receiver including two input terminals connected to the two input/output terminals;
a resistor connected between each of the two input/output terminals and one of a grand and a power supply voltage; and
a comparator configured to compare a voltage between the two transmission lines with a first reference voltage to determine whether the two transmission lines are in an idle state or in a communication state.

2. The transmission device according to claim 1, wherein
the at least one of the nodes further includes:
a pre-charge circuit configured to pull in the voltage between the two transmission lines quickly to an output common mode voltage of the driver; and
a pre-discharge circuit configured to pull in the voltage between the two transmission lines quickly to the grand or the power supply voltage.

3. The transmission device according to claim 1, wherein
the at least one of the nodes further includes:
a comparator configured to compare a second reference voltage with the voltage between the two transmission lines and to determine whether a wakeup signal at a voltage level, which does not occur in a normal signal transmission state, is received; and
a wakeup signal generator circuit configured to generate the wakeup signal.

4. A node for a transmission device including two transmission lines, the node connected in parallel between the two transmission lines and configured to utilize a telecommunications standard of a differential transmission, the node comprising:
two input/output terminals connected to the two transmission lines;
a driver including two output terminals connected to the two input/output terminals;
a receiver including two input terminals connected to the two input/output terminals;
a resistor connected between each of the two input/output terminals and one of a grand and a power supply voltage; and
a comparator configured to compare a voltage between the two transmission lines with a reference voltage to determine whether the two transmission lines are in an idle state or in a communication state.
